(19) United States
(12) Patent Application Publication
(10) Pub. No.: US 2006/0230148 A1
(43) Pub. Date: Oct. 12, 2006

(54) TCP forwarding of client requests of high-level file and storage access protocols in a network file server system

(76) Inventors: John Forecast, Newton, MA (US); Stephen A. Fridella, Newton, MA (US); Sorin Faibish, Newton, MA (US); Xiaoye Jiang, Shrewsbury, MA (US); Uday K, Gupta, Westford, MA (US)

Correspondence Address: RICHARD AUCHTERLONIE;NOVAK DRUCE & QUIGG, LLP, 1000 LOUISIANA, 53RD FLOOR, HOUSTON, TX, 77002, US

(21) Appl. No.: 11/099,912

(22) Filed: Apr. 6, 2005

(51) Int. Cl. G06F 15/173

(52) U.S. Cl. 709/226

(57) ABSTRACT

For each high-level protocol, a respective mesh of Transmission Control Protocol (TCP) connections is set up for a cluster of server computers for the forwarding of client requests. Each mesh has a respective pair of TCP connections in opposite directions between each pair of server computers in the cluster. The high-level protocols, for example, include the Network File System (NFS) protocol, and the Common Internet File System (CIFS) protocol. Each mesh can be shared among multiple clients because there is no need for maintenance of separate TCP connection state for each client. The server computers may use Remote Procedure Call (RPC) semantics for the forwarding of the client requests, and prior to the forwarding of a client request, a new unique transaction ID can substituted for an original transaction ID in the client request so that forwarded requests have unique transaction IDs.

### FIELD OF THE INVENTION

The present invention relates generally to data storage systems, and more particularly to network file servers.

### BACKGROUND OF THE INVENTION

In a data network it is conventional for a network server containing disk storage to service storage access requests from multiple network clients. The storage access requests, for example, are serviced in accordance with a network file access protocol such as the Network File System (NFS) and the Common Internet File System (CIFS). NFS is described, for example, in RFC 1094, Sun Microsystems, Inc., “NFS: Network File Systems Protocol Specification,” Mar. 1, 1989. The CIFS protocol is described, for example, in Paul L. Leach and Dilip C. Naik, “A Common Internet File System,” Microsoft Corporation, Dec. 19, 1997,

A network file server typically includes a digital computer for servicing storage access requests in accordance with at least one network file access protocol, and an array of disk drives. This server computer has been called by various names, such as a storage controller, a data mover, or a file server. The server computer typically performs client authentication, enforces client access rights to particular storage volumes, directories, or files, and maps directory and file names to allocated logical blocks of storage.

Due to the overhead associated with the network file access protocol, the server computer in the network file server may become a bottleneck to network storage access that is shared among a large number of network clients. One way of avoiding such a bottleneck is to use a network file server system having multiple server computers that provide concurrent access to the shared storage. The functions associated with file access are distributed among the server computers so that one computer may receive a client request for access to a specified file, authenticate the client and authorize access of the client to the specified file, and forward the request to another server computer that is responsible for management of exclusive access to a particular file system that includes the specified file. See, for example, Vahalia et al. U.S. Pat. No. 6,192,408 issued Feb. 20, 2001, incorporated herein by reference.

In a network file server system having multiple server computers that provide concurrent access to the shared storage, the server computers may exchange file data in addition to metadata associated with a client request for file access. For example, as described in Xu et al. U.S. Pat. No. 6,324,581 issued Nov. 27, 2001, incorporated herein by reference, each file system is assigned to a data mover computer that has primary responsibility for managing access to the file system. If a data mover computer receives a client request for access to a file in a file system to which access is managed by another data mover, then the secondary data mover that received the client request sends a metadata request to the primary data mover that manages access to the file system. In this situation, the secondary data mover functions as a Forwarder, and the primary file server functions as the Owner of the file system. The primary data mover responds by placing a lock on the file and returning metadata of the file to the secondary data mover. The secondary data mover uses the metadata to formulate a data access command for accessing the file data over a bypass data path that bypasses the primary data mover.

In the network file server of Xu et al. U.S. Pat. No. 6,324,581, requests in accordance with the CIFS protocol can be forwarded over Transmission Control Protocol (TCP) connections between the data mover computers. This is the focus of Jiang et al. U.S. Pat. No. 6,453,354, incorporated herein by reference. As described in Jiang et al., column 21, lines 55-65, there is a fixed number of open static TCP connections pre-allocated between the Forwarder and each Owner. This fixed number of open static TCP connections is indexed by entries of the primary channel table 241. Multiple clients of a Forwarder requesting access to the file systems owned by the same Owner will share the fixed number of open static TCP connections by allocating virtual channels within the fixed number of open static TCP connections. In addition, dynamic TCP connections are built for Write_raw, Read_raw, and Trans commands.

In practice, the method of Xu et al. U.S. Pat. No. 6,324,581 has been most useful for large input/output (I/O) operations. The method of Xu et al. U.S. Pat. No. 6,324,581 has been used commercially in the following manner. For a small I/O operation of less than a given threshold, for example four kilobytes, of data to be read or written to a file system in storage, then the data mover computer in the network file server that is responsible for managing access to the file system will access the requested data in the conventional fashion. In general, the threshold is smaller than the file system block size. For a larger I/O operation of more than the threshold, then the data mover in the network file server that is responsible for managing access to the file system will function as a metadata server as described in Xu et al. U.S. Pat. No. 6,324,581 by placing a lock on the file to be accessed and returning metadata so that the metadata can be used to formulate a read or write request for accessing the data of the file over a path that bypasses the data mover.

### SUMMARY OF THE INVENTION

In a server computer cluster, there is a need for efficient forwarding of client requests in accordance with various high-level file and storage access protocols among the server computers. Forwarding of client requests is used in server clusters in which each of the server computers does not have a direct connection to all of the storage accessed by the cluster. If each of the server computers has a direct connection to all of the storage, then forwarding of client requests is typically used for small I/Os and metadata operations. Forwarding of all kinds of client requests for storage access is also used in server clusters in which each of the server computers does not have a direct connection to all of the storage accessible to the server cluster. However, it is recognized that there is a cost associated with the forwarding of client requests in accordance with high-level protocols. Thus, forwarding should be used only when necessary. Caching at secondary server computers may decrease the required amount of forwarding, and smaller lock ranges may result in more effective use of secondary server computers. Nevertheless, it is desired to increase the efficiency of such client request forwarding, since forwarding over TCP connections may result in a rather large performance drop of up to 20 to 25 percent under high loading conditions. It is expected that more efficient forwarding will improve performance by up to 10% under these conditions.

In accordance with one aspect, the invention provides a method of operation of multiple server computers connected by a data network to client computers for providing the client computers with access to file systems in accordance with a plurality of high-level protocols in which access requests indicate respective file systems to be accessed. Access to each of the file systems is managed by a respective one of the server computers. The method includes, for each of the plurality of high-level protocols, setting up a respective mesh of Transmission Control Protocol (TCP) connections between the server computers for forwarding, between the server computers, access requests in accordance with said each of the plurality of high-level protocol. Each mesh has a respective pair of TCP connections in opposite directions between each pair of the server computers. The method further includes each of the server computers responding to receipt of client requests for access in accordance with the high-level protocols by forwarding at least some of the client requests for access in accordance with the high-level protocols over the respective meshes to other ones of the server computers that manage access to the file systems indicated by the at least some of the client requests for access.

In accordance with another aspect, the invention provides a method of operation of multiple server computers connected by a data network to client computers for providing the client computers with access to file systems in accordance with a plurality of high-level protocols in which access requests indicate respective file systems to be accessed. Access to each of the file systems is managed by a respective one of the server computers. The method includes, for each of the plurality of high-level protocols, setting up a respective mesh of Transmission Control Protocol (TCP) connections between the server computers for forwarding, between the server computers, access requests in accordance with said each of the plurality of high-level protocols. Each mesh has a respective pair of TCP connections in opposite directions between each pair of the server computers. The method further includes each of the server computers responding to receipt of client requests for access in accordance with the high-level protocols by forwarding at least some of the client requests for access in accordance with the high-level protocols over the respective meshes to other ones of the server computers that manage access to the file systems indicated by the at least some of the client requests for access. The high-level protocols include the Network File System (NFS) protocol, and the Common Internet File System (CIFS) protocol. Each mesh is shared among multiple ones of the clients and there is no maintenance of separate TCP connection state for each of the multiple ones of the clients. The server computers use Remote Procedure Call (RPC) semantics for the forwarding of the at least some of the client requests for access in accordance with the high-level protocols over the respective meshes to other ones of the server computers that manage access to the file systems indicated by the at least some of the client requests for access. At least one of the clients has an IP address and sends from the IP address to at least one of the servers at least one request for access including an original transaction ID. The at least one of the server computers responds to receipt of the at least one request for access by assigning a new transaction ID to the at least one client request, caching a mapping of the new transaction ID with the original transaction ID and the IP address, substituting the new transaction ID for the original transaction ID in the at least one request for access, and forwarding the at least one request for access including the substituted new transaction ID to another one of the server computers that manages access to a file system that is indicated by the at least one request for access. The at least one of the server computers receives a reply including the new transaction ID from the another one of the server computers that manages access to the file system that is indicated by the at least one request for access, and in response the at least one of the server computers obtains the new transaction ID from the reply and uses the new transaction ID from the reply to lookup the cached original transaction ID and the IP address, in order to replace the new transaction ID in the reply with the original transaction ID and return the reply to the IP address of the at least one of the clients.

In accordance with yet another aspect, the invention provides a network file server system for connection via a data network to client computers for providing the client computers with access to file systems in accordance with a plurality of high-level protocols in which access requests indicate respective file systems to be accessed. The network file server system includes multiple server computers for connection via the data network to the client computers. The server computers are programmed so that access to each of the file systems is managed by a respective one of the server computers. The server computers are also programmed for setting up a respective mesh of Transmission Control Protocol (TCP) connections between the server computers for forwarding, between the server computers, access requests in accordance with said each of the plurality of high-level protocols. Each mesh has a respective pair of TCP connections in opposite directions between each pair of the server computers. Each of the server computers is also programmed for responding to receipt of client requests for access in accordance with the high-level protocols by forwarding at least some of the client requests for access in accordance with the high-level protocols over the respective meshes to other ones of the server computers that manage access to the file systems indicated by the at least some of the client requests for access.

### BRIEF DESCRIPTION OF THE DRAWINGS

Additional features and advantages of the invention will be described below with reference to the drawings, in which:

FIG. 1 is a block diagram of a data network including a network file server having a cluster of data mover computers providing client access to shared storage in a cached disk array;

FIG. 2 is a block diagram showing data and control flow among the components of the data network of FIG. 1, including a mesh of TCP connections among the data mover computers;

FIG. 3 is a block diagram showing a mesh of TCP connections among four data movers;

FIG. 4 is a block diagram of software modules within a data mover;

FIG. 5 is schematic diagram of a routing table used in each data mover for the data network of FIG. 2;

FIG. 6 is a is schematic diagram of a client transaction ID cache used in each data mover; and

FIGS. 7 to 9 comprise a flowchart of programming of a data mover for multi-protocol forwarding of client requests over a respective mesh of TCP connections between the data movers for each of a plurality of high-level file and storage access protocols.

While the invention is susceptible to various modifications and alternative forms, a specific embodiment thereof has been shown in the drawings and will be described in detail. It should be understood, however, that it is not intended to limit the invention to the particular form shown, but on the contrary, the intention is to cover all modifications, equivalents, and alternatives falling within the scope of the invention as defined by the appended claims.

### DETAILED DESCRIPTION OF THE PREFERRED EMBODIMENT

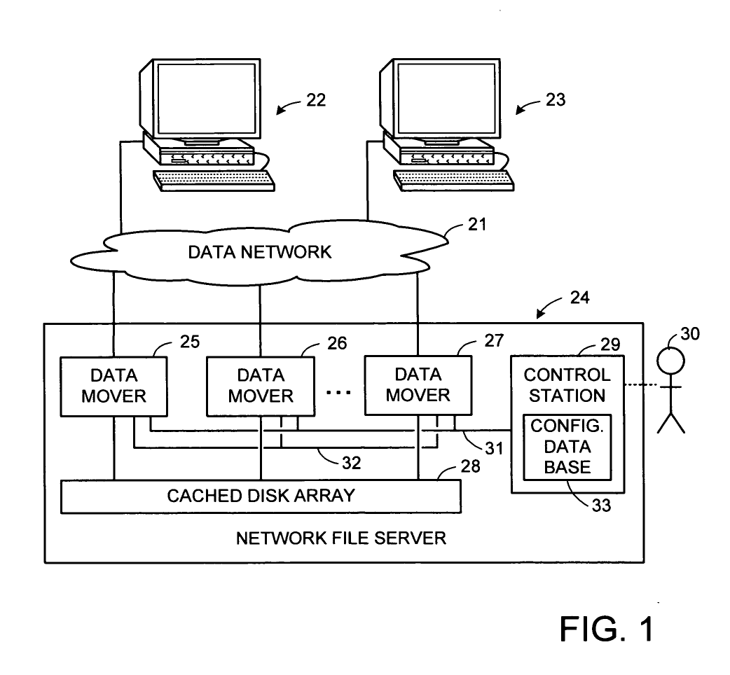

With reference to FIG. 1, there is shown a data processing system incorporating the present invention. The data processing system includes a data network 21 interconnecting a number of clients 22, 23 and servers such as a network file server 24. The data network 21 may include any one or more of network connection technologies, such as Ethernet, and communication protocols, such as TCP/IP. The clients 22, 23, for example, are workstations such as personal computers using either UNIX or Microsoft Windows operating systems. Various aspects of the network file server 24 are further described in Vahalia et al., U.S. Pat. No. 5,893,140 issued Apr. 6, 1999, incorporated herein by reference, and Xu et al., U.S. Pat. No. 6,324,581, issued Nov. 27, 2002, incorporated herein by reference. This kind of network file server is manufactured and sold by EMC Corporation, 176 South Street, Hopkinton, Mass. 01748.

The network file server 24 includes a cached disk array 28 and a number of data mover computers, for example 25, 26, 27, and more. The network file server 24 is managed as a dedicated network appliance, integrated with popular network file systems in a way, which, other than its superior performance, is transparent to the end user. The clustering of the data movers 25, 26, 27 as a front end to the cache disk array 28 provides parallelism and scalability. Each of the data movers 25, 26, 27 is a high-end commodity computer, providing the highest performance appropriate for a data mover at the lowest cost. The network file server 24 also has a control station 29 enabling a system administrator 30 to configure and control the file server. The data movers 25, 26, 27 are linked to the control station 29 and to each other by a dual-redundant Ethernet 31 for system configuration and maintenance, and detecting data mover failure by monitoring heartbeat signals transmitted among the data movers and the control station. The data movers 25, 26, 27 are also linked to each other by a local area IP network 32, such as a gigabit Ethernet.

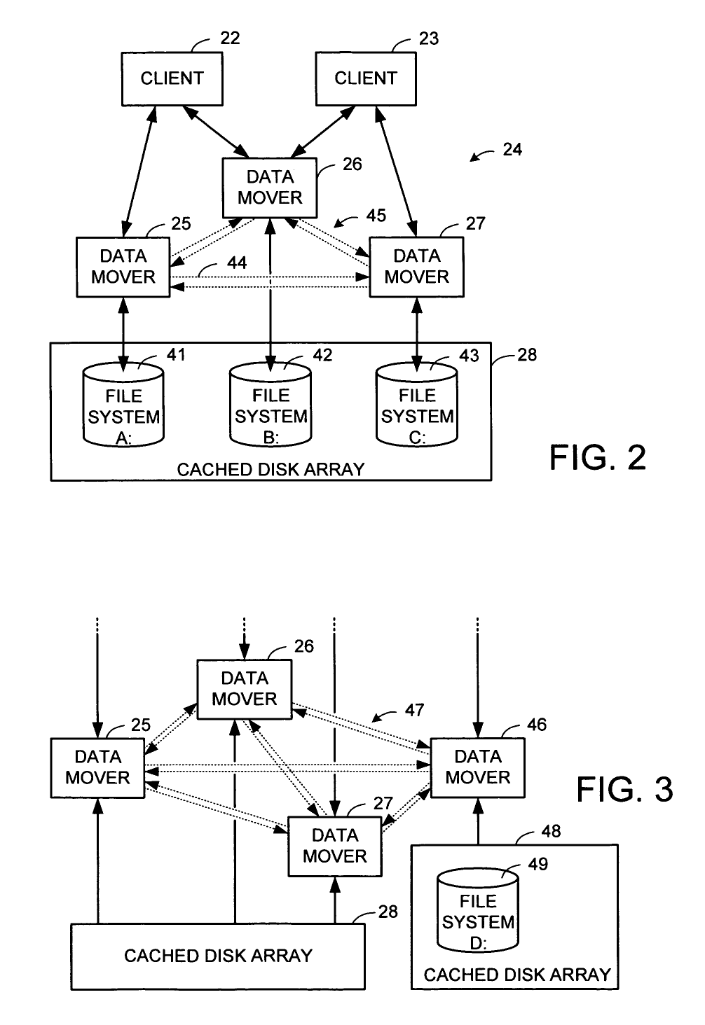

As shown in FIG. 2, the data mover 25 is primary with respect to a file system 41, the data mover 26 is primary with respect to a file system 42, and the data mover 27 is primary with respect to a file system 43. If the data mover 25, for example, receives a request from the client 22 for access to a file in the file system 43, then the data mover 25 will forward the request over the TCP connection 44 to the data mover 27 in order to obtain access to the file system 43.

For more efficient forwarding, a mesh 44 of TCP connections (over the local high-speed Ethernet 32 in FIG. 1) is established among the data movers 25, 26, 27 by setting up a respective pair of TCP/IP connections in opposite directions between each pair of data movers in the cluster. Each TCP/IP connection (indicated by a dashed arrow) is brought up and maintained by execution of a respective code thread initiating transmission from a respective one of the data movers in the pair. Each TCP connection has a different port number for the source port, and a unique port number for the destination port (with respect to the local high-speed Ethernet among the data movers). For example, each TCP connection uses a well-known destination port and an arbitrarily-selected source port.

For multi-protocol forwarding, a respective mesh of TCP connections is set up among the data movers 25, 26, 27 for each of the high-level file and storage access protocols. For example, for forwarding NFS and CIFS requests, a first mesh is set up for forwarding NFS requests, and a second mesh is set up for forwarding CIFS requests. When a mesh is set up, configuration information defining the mesh is stored in a configuration database (33 in FIG. 1) in the control station. A backup copy of the this configuration database is kept in storage of the cached disk array 28.

FIG. 3 shows that when a fourth data mover 46 is added to the cluster, then the number of TCP connections in the mesh 47 is increased from 6 to 12. In general when an Nth data mover is added to the cluster, the new mesh will include 2*(N−1) additional TCP connections, for a total of N*(N−1) connections.

FIG. 3 also shows that each file system accessible to the cluster need not be directly accessible to every data mover in the cluster. Moreover, the data movers of the cluster could be physically located close to each other, or the data movers could be spaced apart from each other by a considerable distance. For example, the data movers of the cluster could be located in the same cabinet, or the data movers could be located in separate cabinets, or in separate rooms of a building, or in separate buildings.

As shown in FIG. 3, for example, the fourth data mover 46 may directly access a file system 69 in a second cached disk array 48, but the fourth data mover 46 may not directly access the file systems in the first cached disk array 28. Therefore, if the fourth data mover 46 receives a request from a client to read from or write to a file system in the first cached disk array 28, then the data of the read or write operation would be transferred over a respective TCP connection between the fourth data mover 46 and the one of the data movers 25, 26, 27 that is primary with respect to the file system in the first cached disk array. In a similar fashion, if one of the data movers 25, 26, 27 receives a request from a client to read from or write to the file system 49 in the cached disk array 48, then the data of the read or write operation would be transferred over a respective TCP connection between the fourth data mover 46 and the one of the data movers 25, 26, 27 that received the request from the client.

The mesh technique is advantageous for fail-over of a failed data mover because each mesh can be re-established by a simple, uniform process upon substitution of a replacement data mover. This process involves accessing the configuration database (33 in FIG. 1) so that each TCP connection over the local high-speed Ethernet with the failed data mover is re-established with the replacement data mover. The replacement data mover takes over the personality of the failed data mover, and starts from a clean connection state.

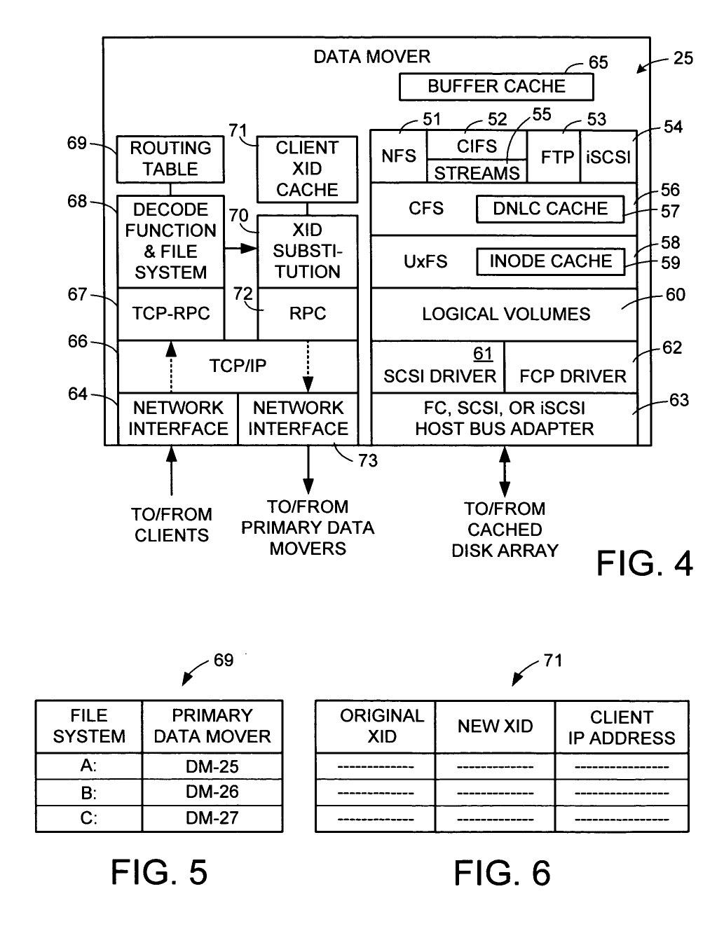

FIG. 4 shows software modules in the data mover 25 introduced in FIG. 1. The data mover 25 has a set of modules for high-level file access protocols used by the clients for accessing files in the network file server. These modules include a network file system (NFS) module 51 for supporting the NFS file access protocol, a Common Internet File System (CIFS) module 52 for supporting the CIFS file access protocol, a module 53 for supporting the File Transfer Protocol (FTP), and a module 54 for supporting the Internet Small Computer System Interface protocol. FTP is described in J. Postel and J. Reynolds, Request for Comments: 959, ISI, October 1985. The iSCSI protocol is described in J. Satran et al., Request for Comments: 3720, Network Working Group, The Internet Society, April 2004.

The CIFS module 52 is layered over a File Streams module 55. The NFS module 51, the CIFS module 52, the File Streams module 55, the FTP module 53, and the iSCSI module 54 are layered over a Common File System (CFS) module 56. The CFS module 56 maintains a Dynamic Name Lookup Cache (DNLC) 57. The DNLC does file system pathname to file handle translation. The CFS 56 module is layered over a Universal File System (UxFS) module 58. The UxFS module 58 supports a UNIX-based file system, and the CFS module 56 provides higher-level functions common to NFS and CIFS. The UxFS module 34 maintains a file system inode cache 59.

The UxFS module 58 accesses data organized into logical volumes defined by a module 60. Each logical volume maps to contiguous logical storage addresses in the cached disk array. The module 60 is layered over an SCSI driver 61 and a Fibre-channel protocol (FCP) driver 62. The data mover 25 sends storage access requests through a host bus adapter 63 using the SCSI protocol, the iSCSI protocol, or the Fibre-Channel protocol, depending on the physical link between the data mover 25 and the cached disk array.

A network interface card 59 in the data mover 25 receives IP data packets from the network clients. A TCP/IP module 40 decodes data from the IP data packets for the TCP connection and stores the data in buffer cache 65. For example, the UxFS layer 58 may write data from the buffer cache 65 to a file system in the cached disk array. The UxFS layer 58 may also read data from a file system in the cached disk array and copies the data into the buffer cache 46 for transmission to a network client.

A network client may use the User Datagram Protocol (UDP) protocol for sending requests to the data mover 25. In this case, a TCP-RPC module 67 converts a TCP byte stream into UDP-like messages.

When the data mover receives a client request, a module 68 decodes the function of the request and determines if it accesses a particular file system. If so, a routing table 69 is accessed to determine the data mover that is responsible for management of access to the particular file system. For the system as shown in FIG. 2, the contents of the routing table 69 are shown in FIG. 5. If another data mover is responsible for management of access to the particular file system, then the request is forwarded to the other data mover.

Each request from each client may contain a transaction ID (XID). It is possible that different clients may assign the same XID. Therefore, for forwarding of the request over a mesh, the data mover 25 has an XID substitution module that assigns a new unique XID, and stores in a client XID cache 71 a mapping of the original XID in the client request in association with the IP address of the client and the new unique XID, and substitutes the new unique XID for the original XID in the request before forwarding the request to the primary data mover. The client XID cache is shown in FIG. 6.

For forwarding a client request to another data mover, a remote procedure module (RPC) 72 packages the request as a remote procedure call. RPC involves a caller sending a request message to a remote system to execute a specified procedure using arguments in the request message. The RPC protocol provides for a unique specification of procedure to be called, provisions for matching response messages to request messages, and provisions for authenticating the caller to the service and vice-versa. RPC (Version 2) is described in Request for Comments: 1057, Sun Microsystems, Inc., June 1988. In a data mover cluster, the caller is a secondary data mover, and the remote system is a primary data mover.

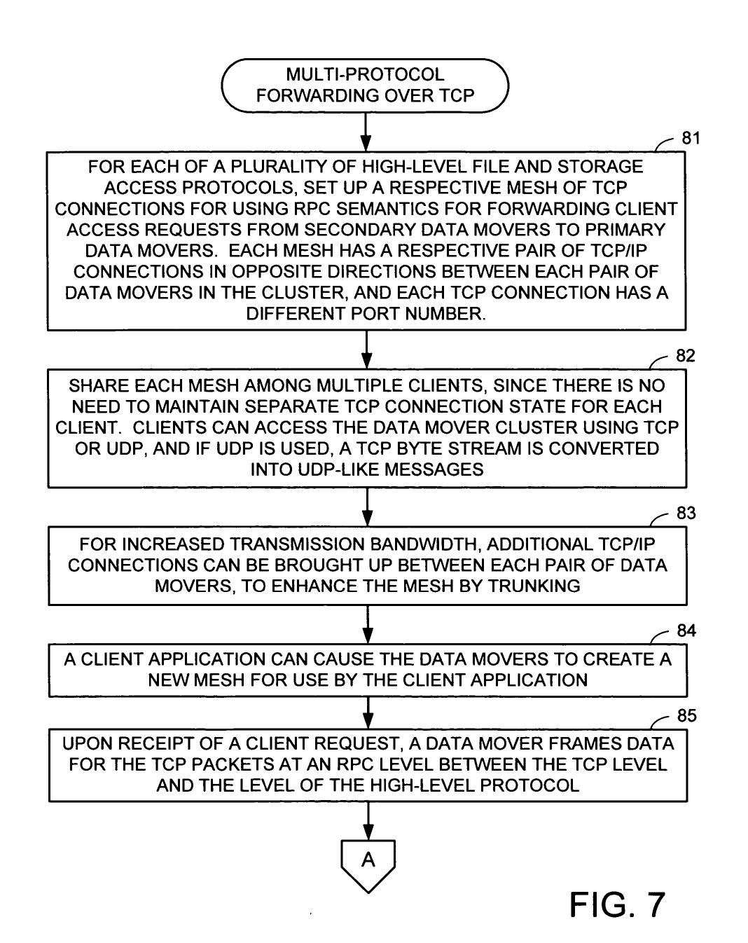

FIG. 7 shows the general procedure used for multi-protocol forwarding over TCP connections between the data movers in a cluster. In a first step 81, for each of a plurality of high-level file and storage access protocols, a respective mesh of TCP connections is set up for using remote procedure call (RPC) semantics for forwarding client access requests from secondary data movers to primary data movers. For example, the high-level file and storage access protocols include NFS, CIFS, FTP, and iSCSI. As introduced above, each mesh has a respective pair of TCP/IP connections in opposite directions between each pair of data movers in the cluster, and each TCP connection has a different port number for the source port, and a unique port number for the destination port (with respect to the local high-speed Ethernet among the data movers).

When a secondary data mover receives a high-level access request form a network client and determines that another data mover is primary with respect to the file system indicated by the request, then the secondary data mover puts the high-level access request into a remote procedure call and sends the remote procedure call to the primary data mover over the TCP connection in the respective mesh for the high-level access protocol.

In step 82, each mesh is shared among multiple network clients, since there is no need to maintain separate TCP connection state for each client. The clients access the data mover cluster using TCP or UDP. When a client accesses the data mover cluster using UDP, a TCP byte stream is converted into UDP-like messages. In step 83, for increased transmission bandwidth, additional TCP/IP connections can be brought up between each pair of data movers, to enhance a mesh by a technique called trunking. In step 84, a client application can cause a new mesh to be created for its own use.

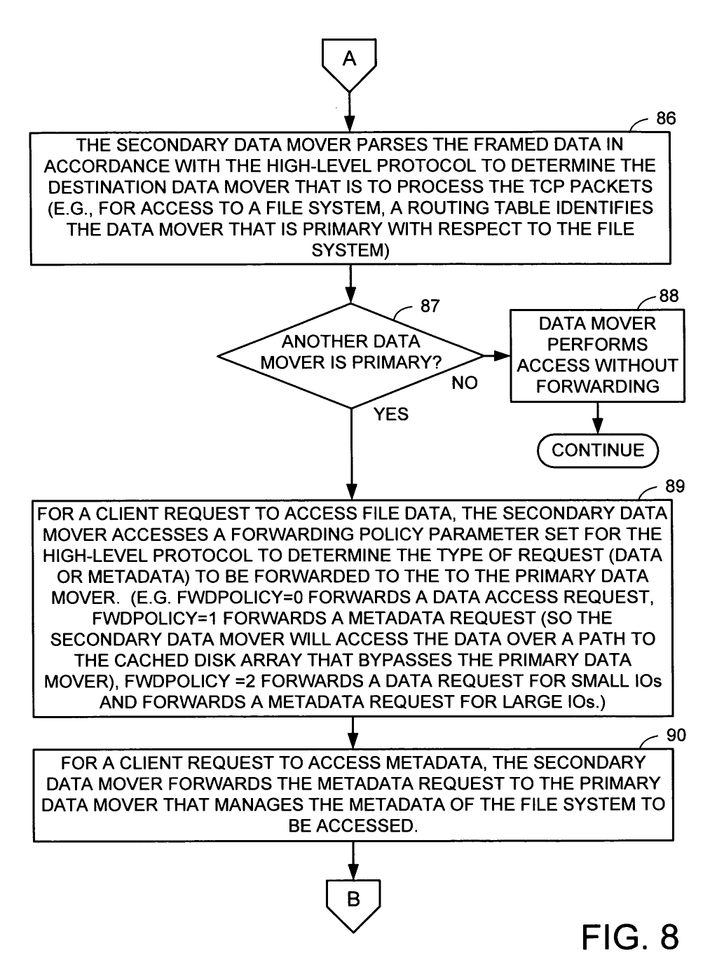

In step 85, for forwarding TCP packets of a client access request, the data of the TCP packets are framed at an RPC level between the TCP level and the high-level protocol level. The procedure continues from step 85 to step 86 in FIG. 8. In step 86, the framed data are parsed in accordance with the high-level protocol to determine the data mover that is to process the TCP packets. For example, for file access, the data mover parses the framed data to determine the function to perform (metadata access, or read or write data access), and to determine the file system to be accessed, and a routing table in the data mover is accessed to find the data mover that is to perform the desired function for the indicated file system. For NFS over TCP, for example, the framed NFS data include a function code, followed by authentication information, followed by a file handle. The NFS data are parsed to find the function and the file handle.

In step 87, if another data mover is not primary with respect to the desired function for the indicated file system, then execution continues to step 88. In step 88, the data mover performs the function without forwarding. Otherwise, if another data mover is primary, then execution continues from step 87 to step 89.

In step 89, for a client request to access file data, the secondary data mover accesses a forwarding policy parameter (FWDPOLICY) set for the high-level protocol to determine the type of request (data or metadata) to be forwarded to the primary data mover. For example, the forwarding policy parameter is a run-time parameter that is initially set at boot time with a configuration value. Possible values include FWDPOLICY=0 in which each data access request is forwarded as a data access request to the primary data mover, FWDPOLICY=1 in which a metadata request is forwarded to the primary data mover so that the secondary data mover may obtain the metadata and directly access the data over a path to the cached disk array that bypasses the primary data mover, and FWDPOLICY=2 in which the secondary data over forwards a data access request for small IOs and a metadata access request for large IOs.

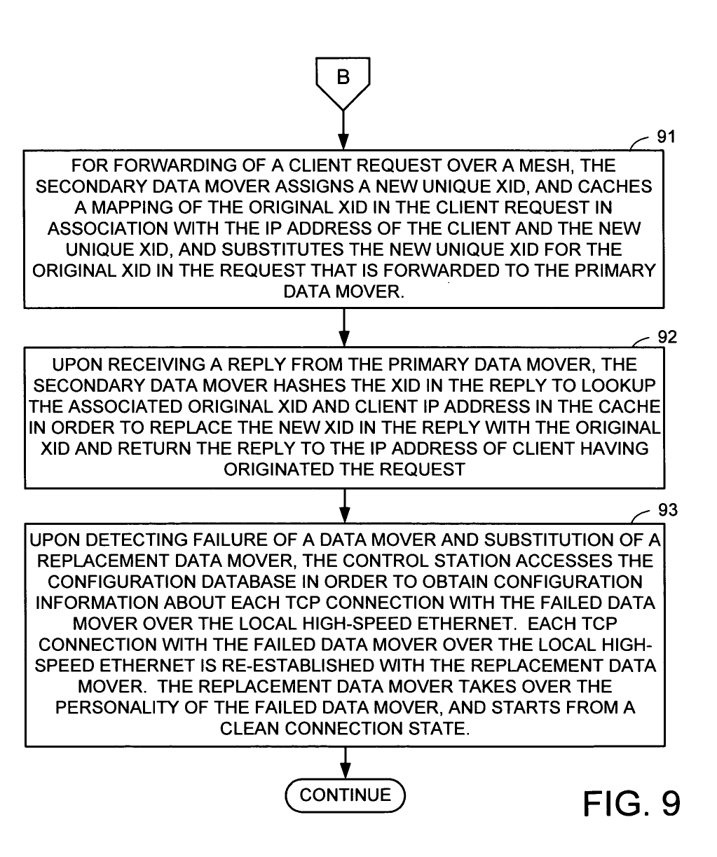

In step 90, for the case of a metadata request from a client, the secondary data mover forwards the metadata request to the primary data mover that manages the metadata of the file system to be accessed. The procedure continues from step 90 to step 91 in FIG. 9

Each request from each client may contain a transaction ID (XID). It is possible that different clients may assign the same XID. Therefore, in step 91, for forwarding of the request over a mesh, the secondary data mover assigns a new unique XID, and caches a mapping of the original XID in the client request in association with the IP address of the client and the new unique XID, and substitutes the new unique XID for the original XID in the request before forwarding the request to the primary data mover. In step 92, upon receiving a reply from the primary data mover, the secondary data mover hashes the XID in the reply to lookup the associated original XID and client IP address in the cache in order to replace the new XID in the reply with the original XID and return the reply to the IP address of the client having originated the request.

In step 93, upon detecting failure of a data mover and substitution of a replacement data mover, the control station accesses the configuration database in order to obtain configuration information about each TCP connection with the failed data mover over the local high-speed Ethernet. Each TCP connection with the failed data mover over the local high-speed Ethernet is re-established with the replacement data mover. The replacement data mover takes over the personality of the failed data mover, and starts from a clean connection state.

The data mover cluster handles two classes of client CIFS requests. The first class is associated with port no. 139, and the second class is associated with port no. 445.

A client CIFS request associated with port no. 139 (traditional CIFS) starts with the client establishing a TCP connection with a data mover in the cluster. The client then sends a session request having a NETBIOS name. A table lookup is done to determine if the request is to be forwarded to another location. The client may also connect via an IP address. In this case, the client replaces the NETBIOS name with a default value (“*SMBSERVER”) which is not sufficiently unique to identify where to forward the request. In this case, the target IP address (IP address of the secondary Data Mover) may be used to identify where to forward the request.

A client CIFS request associated with port no. 445 (CIFS for Win 2K) requires Kerberos authentication. The data movers locally cache the authentication information. A secondary data mover receives a tree connect request from the client. The tree connect request specifies a file system to access. The tree connection request is authenticated by the secondary data mover, forwarded to the primary data mover, and re-authenticated at the primary data mover. NFSV4 uses this same mechanism as CIFS port 445.

In view of the above, there is a need for efficient forwarding of client requests in accordance with various high-level file and storage access protocols among data movers in a cluster. For each high-level protocol, a respective mesh of Transmission Control Protocol (TCP) connections is set up for the cluster for the forwarding of client requests. Each mesh has a respective pair of TCP connections in opposite directions between each pair of data movers in the cluster. The high-level protocols, for example, include the Network File System (NFS) protocol, and the Common Internet File System (CIFS) protocol. Each mesh can be shared among multiple clients because there is no need for maintenance of separate TCP connection state for each client. The server computers may use Remote Procedure Call (RPC) semantics for the forwarding of the client requests, and prior to the forwarding of a client request, a new unique transaction ID can substituted for an original transaction ID in the client request so that forwarded requests have unique transaction IDs.

What is claimed is:

1. A method of operation of multiple server computers connected by a data network to client computers for providing the client computers with access to file systems in accordance with a plurality of high-level protocols in which access requests indicate respective file systems to be accessed, access to each of the file systems being managed by a respective one of the server computers, said method comprising:
for each of the plurality of high-level protocols, setting up a respective mesh of Transmission Control Protocol (TCP) connections between the server computers for forwarding, between the server computers, access requests in accordance with said each of the plurality of high-level protocols; each mesh having a respective pair of TCP connections in opposite directions between each pair of the server computers; and
each of the server computers responding to receipt of client requests for access in accordance with the high-level protocols by forwarding at least some of the client requests for access in accordance with the high-level protocols over the respective meshes to other ones of the server computers that manage access to the file systems indicated by said at least some of the client requests for access.

2. The method as claimed in claim 1, wherein the high-level protocols include the Network File System (NFS) protocol, the Common Internet File System (CIFS) protocol, the File Transfer Protocol (FTP), and the Internet Small Computer System Interface (iSCSI) protocol.

3. The method as claimed in claim 1, wherein each mesh is shared among multiple ones of the client computers and there is no maintenance of separate TCP connection state for each of the multiple ones of the client computers.

4. The method as claimed in claim 1, wherein at least one of the client computers uses the User Datagram Protocol (UDP) for transmission of at least one of the access requests in accordance with at least one of the high-level protocols over the data network to at least one of the server computers, and said at least one of the server computers forwards said at least one of the access requests over a TCP connection of the respective mesh for said at least one of the high-level protocols to another one of the server computers that manages one of the file systems that is indicated by said at least one of the access requests in accordance with said at least one of the high-level protocols, and said at least one of the server computers converts a TCP byte stream into a UDP-like message during servicing of said at least one of the access request.

5. The method as claimed in claim 1, wherein the server computers use Remote Procedure Call (RPC) semantics for the forwarding of said at least some of the client requests for access in accordance with the high-level protocols over the respective meshes to other ones of the server computers that manage access to the file systems indicated by said at least some of the client requests for access.

6. The method as claimed in claim 1, which includes adding additional TCP connections to at least one of the meshes to increase transmission bandwidth of said at least one of the meshes.

7. The method as claimed in claim 1, which includes at least one of the server computers creating a new mesh for use by a client application.

8. The method as claimed in claim 1, which includes at least one of the server computers accessing a forwarding policy parameter set for at least one of the high-level protocols to determine whether to forward to another one of the server computers either a data request or a metadata request in response to receipt of at least one client request for access in accordance with said at least one of the high-level protocols.

9. The method as claimed in claim 1, which includes at least one of the client computers having an IP address and sending from the IP address to at least one of the server computers at least one request for access including an original transaction ID, and said at least one of the server computers responding to receipt of said at least one request for access by assigning a new transaction ID to said at least one client request, caching a mapping of the new transaction ID with the original transaction ID and the IP address, substituting the new transaction ID for the original transaction ID in said at least one request for access, and forwarding said at least one request for access including the substituted new transaction ID to another one of the server computers that manages access to a file system that is indicated by said at least one request for access.

10. The method as claimed in claim 9, which includes said at least one of the server computers receiving a reply including the new transaction ID from said another one of the server computers that manages access to the file system that is indicated by said at least one request for access, and in response said at least one of the server computers obtaining the new transaction ID from the reply and using the new transaction ID from the reply to lookup the cached original transaction ID and the IP address, in order to replace the new transaction ID in the reply with the original transaction ID and return the reply to the IP address of said at least one of the client computers.

11. A method of operation of multiple server computers connected by a data network to client computers for providing access to file systems in accordance with a plurality of high-level protocols in which access requests indicate respective file systems to be accessed, access to each of the file systems being managed by a respective one of the server computers, said method comprising:
for each of the plurality of high-level protocols, setting up a respective mesh of Transmission Control Protocol (TCP) connections between the server computers for forwarding, between the server computers, access requests in accordance with said each of the plurality of high-level protocols; each mesh having a respective pair of TCP connections in opposite directions between each pair of the server computers; and
each of the server computers responding to receipt of client requests for access in accordance with the high-level protocols by forwarding at least some of the client requests for access in accordance with the high-level protocols over the respective meshes to other ones of the server computers that manage access to the file systems indicated by said at least some of the client requests for access;
wherein the high-level protocols include the Network File System (NFS) protocol, and the Common Internet File System (CIFS) protocol;
wherein each mesh is shared among multiple ones of the client computers and there is no maintenance of separate TCP connection state for each of the multiple ones of the client computers;
wherein the server computers use Remote Procedure Call (RPC) semantics for the forwarding of said at least some of the client requests for access in accordance with the high-level protocols over the respective meshes to other ones of the server computers that manage access to the file systems indicated by said at least some of the client requests for access;
which includes at least one of the client computers having an IP address and sending from the IP address to at least one of the server computers at least one request for access including an original transaction ID, and said at least one of the server computers responding to receipt of said at least one request for access by assigning a new transaction ID to said at least one client request, caching a mapping of the new transaction ID with the original transaction ID and the IP address, substituting the new transaction ID for the original transaction ID in said at least one request for access, and forwarding said at least one request for access including the substituted new transaction ID to another one of the server computers that manages access to a file system that is indicated by said at least one request for access; and
which includes said at least one of the server computers receiving a reply including the new transaction ID from said another one of the server computers that manages access to the file system that is indicated by said at least one request for access, and in response said at least one of the server computers obtaining the new transaction ID from the reply and using the new transaction ID from the reply to lookup the cached original transaction ID and the IP address, in order to replace the new transaction ID in the reply with the original transaction ID and return the reply to the IP address of said at least one of the client computers.

12. A network file server system for connection via a data network to client computers for providing the client computers with access to file systems in accordance with a plurality of high-level protocols in which access requests indicate respective file systems to be accessed; said network file server system comprising, in combination:
multiple server computers for connection via the data network to the client computers, the plurality of server computers being programmed so that access to each of the file systems is managed by a respective one of the server computers, said server computers being programmed for setting up a respective mesh of Transmission Control Protocol (TCP) connections between the server computers for forwarding, between the server computers, access requests in accordance with said each of the plurality of high-level protocols, each mesh having a respective pair of TCP connections in opposite directions between each pair of the server computers; and
each of the server computers being programmed for responding to receipt of client requests for access in accordance with the high-level protocols by forwarding at least some of the client requests for access in accordance with the high-level protocols over the respective meshes to other ones of the server computers that manage access to the file systems indicated by said at least some of the client requests for access.

13. The network file server system as claimed in claim 12, wherein the high-level protocols include the Network File System (NFS) protocol, the Common Internet File System (CIFS) protocol, the File Transfer Protocol (FTP), and the Internet Small Computer System Interface (iSCSI) protocol.

14. The network file server system as claimed in claim 12, which is programmed for detecting failure of a data mover, and upon substitution of a replacement data mover for the failed data mover, accessing a configuration database in order to obtain configuration information about each TCP connection with the failed data mover in each mesh and using the configuration information for re-establishing each TCP connection with the failed data mover in each mesh so that each TCP connection with the failed data mover in each mesh is re-established with the replacement data mover.

15. The network file server system as claimed in claim 12, wherein at least one of the server computers is programmed for receiving from at least one of the client computers at least one of the access requests in accordance with at least one of the high-level protocols transmitted over the data network using the User Datagram Protocol (UDP), and said at least one of the server computers is programmed for forwarding said at least one of the access requests over a TCP connection of the respective mesh for said at least one of the high-level protocols to another one of the server computers that manages one of the file systems that is indicated by said at least one of the access requests in accordance with said at least one of the high-level protocols, and said at least one of the server computers is programmed for converting a TCP byte stream into a UDP-like message for servicing of said at least one of the access requests.

16. The network file server system as claimed in claim 12, wherein the server computers are programmed for using Remote Procedure Call (RPC) semantics for the forwarding of said at least some of the client requests for access in accordance with the high-level protocols over the respective meshes to other ones of the server computers that manage access to the file systems indicated by said at least some of the client requests for access.

17. The network file server system as claimed in claim 12, wherein at least one of the server computers is programmed for creating a new mesh for use by a client application.

18. The network file server system as claimed in claim 12, wherein at least one of the server computers is programmed for accessing a forwarding policy parameter set for at least one of the high-level protocols to determine whether to forward to another one of the server computers either a data request or a metadata request in response to receipt of at least one client request for access in accordance with said at least one of the high-level protocols.

19. The network file server system as claimed in claim 12, wherein said at least one of the server computers is programmed for receiving from at least one of the client computers at least one request for access including an original transaction ID, and said at least one of the server computers is programmed for responding to receipt of said at least one request for access by assigning a new transaction ID to said at least one client request, caching a mapping of the new transaction ID with the original transaction ID, substituting the new transaction ID for the original transaction ID in said at least one request for access, and forwarding said at least one request for access including the substituted new transaction ID to another one of the server computers that manages access to a file system that is indicated by said at least one request for access.

20. The network file server system as claimed in claim 19, wherein said at least one of the server computers is programmed for receiving a reply including the new transaction ID from said another one of the server computers that manages access to the file system that is indicated by said at least one request for access, and for said at least one of the server computers obtaining the new transaction ID from the reply and using the new transaction ID from the reply to lookup the cached original transaction ID and the IP address, in order to replace the new transaction ID in the reply with the original transaction ID and return the reply to said at least one of the client computers.
